(19) United States
(12) Patent Application Publication
(10) Pub. No.: US 2012/0044991 A1
(43) Pub. Date: Feb. 23, 2012

(54) MOVING IMAGE CODING APPARATUS AND MOVING IMAGE CODING METHOD

(75) Inventor: Atsushi Mochizuki, Kanagawa (JP)

(73) Assignee: KABUSHIKI KAISHA TOSHIBA, Tokyo (JP)

(21) Appl. No.: 12/885,779

(22) Filed: Sep. 20, 2010

(30) Foreign Application Priority Data
Aug. 20, 2010 (JP) 2010-185256

(51) Int. Cl. H04N 7/32

(52) U.S. Cl. 375/240.12; 375/E07.243

(57) ABSTRACT

A moving image coding apparatus of one embodiment includes a prediction image generator that generates a prediction image abased on a moving image, a processor that performs deblocking process based on residual data that is generated based on a prediction residual being a difference between an input image of the moving image and the prediction image, and the prediction image, and an evaluator that evaluates the deblocking process based on the input image, the residual data, the prediction image, and the deblocked data. The moving image coding apparatus further includes a parameter determiner that calculates a threshold for determining presence or absence of the deblocking process based on a result of the evaluation by the evaluator and determines a parameter for deblocking based on the threshold, and an encoder that codes moving image data based on the prediction residual and the parameter.

### CROSS-REFERENCE TO RELATED APPLICATIONS

This application is based upon and claims the benefit of priority from the prior Japanese Patent Application No. 2010-185256, filed on Aug. 20, 2010; the entire contents of which are incorporated herein by reference.

### FIELD

Embodiments described herein relate generally to a moving image coding apparatus and a moving image coding method for generating a code for a moving image decoding apparatus that includes a deblocking filter.

### BACKGROUND

In a system for dividing a moving image into blocks and coding the moving image in units of the blocks, lines that are not present in an original image sometimes appear at block boundaries because of degradation due to the coding. Therefore, in a conventional moving image coding apparatus, presence or absence of block noise is detected by detecting edges at the block boundaries, and a flag for indicating the presence or absence of the block noise is added to a code for each block. Furthermore, a moving image decoding apparatus removes the block noise by applying a deblocking filter, which is typically used for smoothing brightness, based on the flag.

Specifically, in the moving image coding apparatus, an input image and a coded image are input to a distortion detecting unit, presence or absence of block noise is determined by detecting edges, and a result of the determination is input to a VLS (Variable Length Code) unit and added to the coded image. However, in this method, because a code is added to each block, the amount of codes per frame increases. Furthermore, because only the presence or absence of the block noise is obtained, there is a problem in that whether the block noise is reduced by the deblocking filter applied at the time of decoding or how much the image is blurred by the deblocking filter is not evaluated.

Moreover, while there has been proposed a deblocking filter that appropriately sets the intensity to reduce noise at the block boundaries, this filter requires processing based on data that has been coded once, so that operations and costs increase.

### BRIEF DESCRIPTION OF THE DRAWINGS

FIG. 1 is a diagram illustrating the state of a two-dimensional array of pixel values with respect to the boundaries of DCT (Discrete Cosine Transform) blocks;

FIG. 2 is a block diagram illustrating a configuration of a moving image coding apparatus according to an embodiment;

FIG. 3 is a flowchart of a procedure of determining a threshold for determining ON/OFF of deblocking according to the embodiment;

FIG. 4 is a diagram illustrating positions of DCT block boundaries in a MB when a DCT block size is 4×4 pixels according to the embodiment;

FIG. 5 is a diagram illustrating positions of DCT block boundaries in a MB when a DCT block size is 8×8 pixels according to the embodiment;

FIG. 6 is a flowchart of a procedure of evaluating the effect of deblocking process according to the embodiment;

FIG. 7 is a flowchart of a procedure of region segmentation for determining an application range of a deblocking threshold according to the embodiment; and

FIG. 8 is a flowchart of a procedure of determining an update value of the deblocking threshold according to the embodiment.

### DETAILED DESCRIPTION

In one embodiment, a moving image coding apparatus includes a prediction image generator that generates a prediction image based on input moving image data, a deblocking processor that performs deblocking process based on residual data generated based on a prediction residual that is a difference between an input image constituting the moving image data and the prediction image, and the prediction image, and a deblocking effect evaluator that evaluates the deblocking process based on the input image, the residual data, the prediction image, and data after the deblocking process. The moving image coding apparatus of the embodiment further includes a deblocking parameter determiner that calculates a threshold for determining presence or absence of the deblocking process based on a result of the evaluation performed by the deblocking effect evaluator and determines a coding parameter for deblocking based on the threshold, and an encoder that codes the moving image data based on the prediction residual and the coding parameter.

Exemplary embodiments of a moving image coding apparatus and a moving image coding method according to the present invention are explained in detail below with reference to the accompanying drawings. The present invention is not limited to the following embodiments.

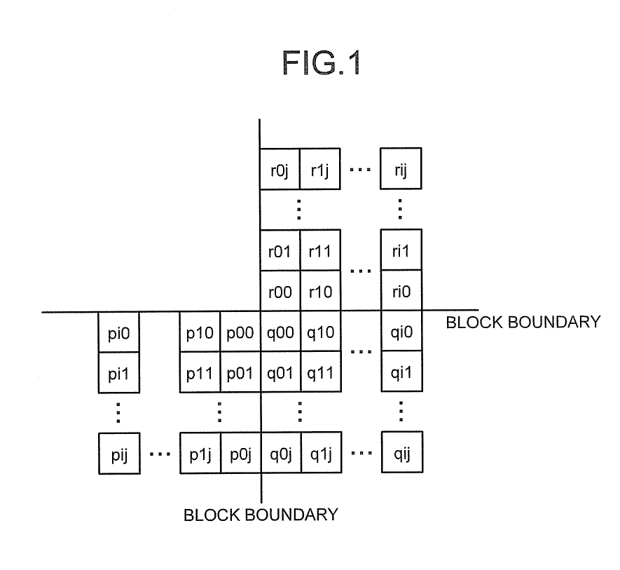

In an embodiment of the present invention, explanation is given on the assumption that a bit stream compliant with, for example, MPEG-4, AVC/H.264, or the like is generated. FIG. 1 illustrates the state of a two-dimensional array of pixel values with respect to the boundaries of DCT blocks each being used as a unit of DCT (Discrete Cosine Transform)

When four pixel values p1j, p0j, q0j, and q1j are arranged in a line in the horizontal direction on the bottom center with a DCT block boundary in the vertical direction placed in the middle of the pixel values, and if Expression (1) is satisfied, a deblocking filter is applied.

|p0j−q0j|<α,|p0j−p1j|<β, and |q0j−q1j|<β (1)

Furthermore, when four pixel values ri1, ri0, qi0, and qi1 are arranged in a line in the vertical direction on the right center with a block boundary in the horizontal direction placed in the middle of the pixel values, and if Expression (2) is satisfied, the deblocking filter is applied.

|ri0−qi0|<α,|ri0−ri1|<β, and |qi0−qi1|<β (2)

where α and β are thresholds for determining ON/OFF of the deblocking filter.

In the embodiment described below, explanation is given with an example in which a brightness value is used as a pixel value. However, a color difference value may be used as the pixel value, or both the brightness value and the color difference value may be used as the pixel value.

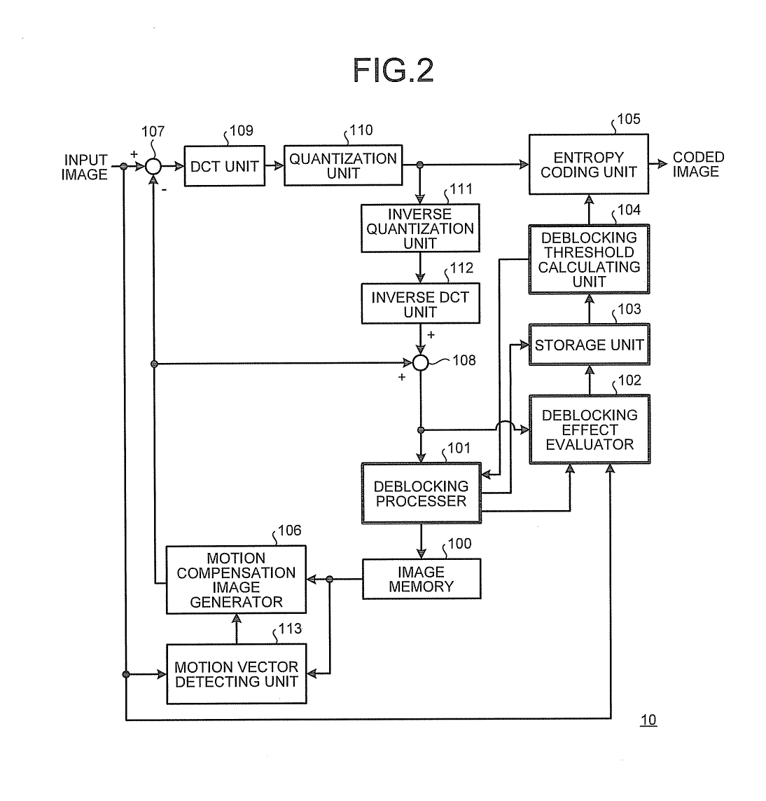

FIG. 2 is a block diagram illustrating a configuration of a moving image coding apparatus 10 according to the embodiment. The moving image coding apparatus 10 includes an image memory 100 for storing data obtained by deblocking process by a deblocking processor 101 to be described later, a motion vector detecting unit 113 that calculates a motion vector based on an input image and the data stored in the image memory 100, a motion compensation image generator (prediction image generator) 106 that generates a prediction image based on the data stored in the image memory 100 and the motion vector calculated by the motion vector detecting unit 113, an arithmetic circuit 107 that calculates a difference between the input image and the prediction image, i.e., a prediction residual, a DCT unit 109 that performs DCT on the prediction residual, a quantization unit 110 that quantizes the output result from the DCT unit 109, an entropy coding unit (an encoder) 105 that generates coded image data based on the output result from the quantization unit 110, an inverse quantization unit 111 that inversely quantizes the output result from the quantization unit 110, an inverse DCT unit 112 that performs inverse DCT on the output result from the inverse quantization unit 111, and an arithmetic circuit 108 that calculates and outputs the sum of residual data that is the output result from the inverse DCT unit 112 and the prediction image.

The moving image coding apparatus 10 further includes the deblocking processor 101 that performs deblocking process similar to that performed at the time of decoding, a deblocking effect evaluator 102 that evaluates the effect of the deblocking filter, a storage unit 103 for storing a result from the deblocking effect evaluator 102 for each frame, and a deblocking threshold calculating unit (deblocking parameter determiner) 104 that calculates the values of the thresholds α and β and the application range of the thresholds α and β based on the evaluation result stored in the storage unit 103.

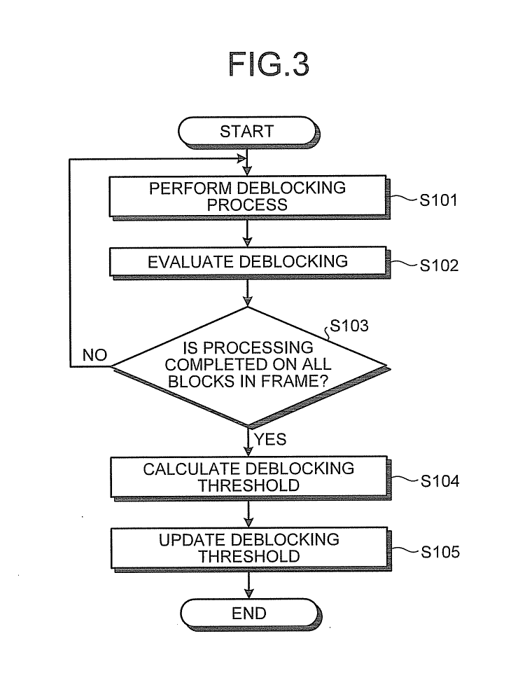

FIG. 3 illustrates a flowchart of a procedure of updating the thresholds α and β for determining ON/OFF of the deblocking according to the embodiment. One image frame is coded in a unit of a macroblock (hereinafter, referred to as MB) with 16×16 pixels. The moving image coding apparatus 10 performs deblocking process and evaluates the effect of the deblocking process in a process on each MB, and updates the thresholds α and β.

In the deblocking process performed by the deblocking processor 101, the deblocking process is performed on each MB regardless of α and β (S101). That is, the deblocking process is unconditionally performed on the whole non-deblocked image that is an output from the arithmetic circuit 108.

Next, the deblocking effect evaluator 102 evaluates the deblocking process performed on each MB by using the images before and after the deblocking process and the input image (S102). When the processing on all of the MBs in one frame is completed (YES at S103), the deblocking threshold calculating unit 104 calculates the values of α and β to be used for a next frame and the application range of α and β based on the evaluation result of the deblocking performed on the whole frame (S104), and updates the thresholds α and β depending on the result (S105).

Described in detail below is the operation of the main components of the moving image coding apparatus 10 according to the embodiment.

(Deblocking Processor 101)

The deblocking processor 101 performs the deblocking process on the non-deblocked image output from the arithmetic circuit 108 regardless of the determination by Expressions (1) and (2). However, to the image memory 100, an image after the deblocking process is output for a portion where Expressions (1) and (2) are satisfied, and an image before the deblocking process is output for a portion where Expressions (1) and (2) are not satisfied. The deblocking processor 101 sends the whole deblocked image to the deblocking effect evaluator 102.

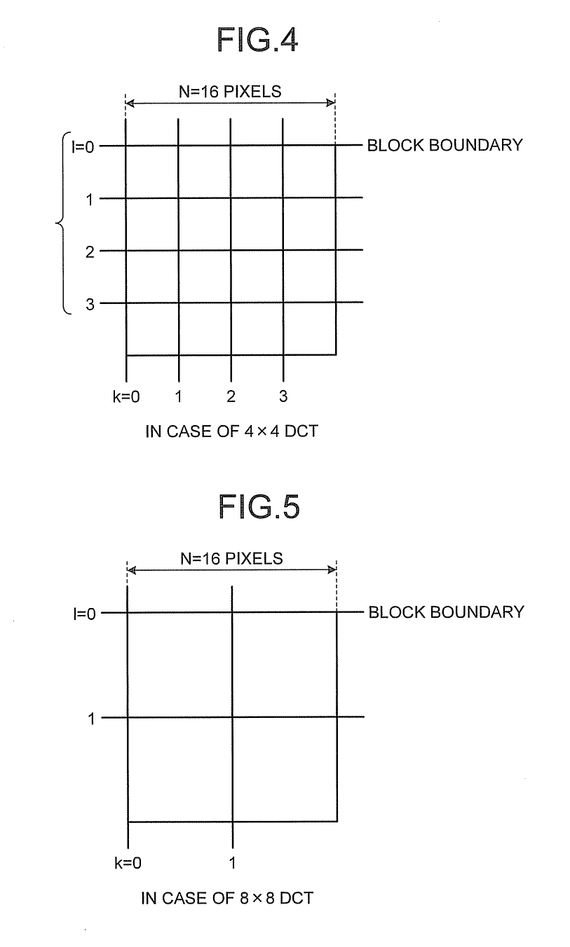

It is assumed here that the number of pixels in an MB in each of the vertical direction and the horizontal direction is N (=16), and the number of DCT blocks in the MB in each of the vertical direction and the horizontal direction is M. The positions of the DCT block boundaries in the MB are illustrated in FIG. 4 and FIG. 5. When a DCT block size at the time of coding is 4×4 pixels as shown in FIG. 4, M=4, and, when the DCT block size is 8×8 pixels as shown in FIG. 5, M=2. It is also assumed that a vertical index of the block boundaries is k and a horizontal index of the block boundaries is 1.

The deblocking processor 101 calculates, for each MB, an average val_for_alpha of |p0j−q0j| and |ri0−qi0| and an average val_for_beta of |p0j−p1j|, |q0j−q1j|, |ri0−ri1|, and |qi0−qi1| calculated for determining the thresholds at each DCT block boundary, according to Expressions (3) and (4), and outputs the averages to the storage unit 103.

$$\begin{matrix}val\_for \_alpha = \frac{{\sum }_{k = 0}^{M - 1} {\sum }_{j = 0}^{N - 1} \vert {p}_{k 0 j} - {q}_{k 0 j} \vert + {\sum }_{l = 0}^{M - 1} {\sum }_{i = 0}^{N - 1} \vert {r}_{li 0} - {q}_{li 0} \vert}{N \times 2 M} & ( 3 ) \\ val\_for \_beta = \frac{{\sum }_{k = 0}^{M - 1} {\sum }_{j = 0}^{N - 1} ( \vert {p}_{k 0 j} - {p}_{k 1 j} \vert + \vert {q}_{k 0 j} - {q}_{k 1 j} \vert ) + {\sum }_{l = 0}^{M - 1} {\sum }_{i = 0}^{N - 1} ( \vert {r}_{li 0} - {r}_{li 1} \vert + \vert {q}_{li 0} - {q}_{li 1} \vert )}{2 \times N \times 2 M} & ( 4 )\end{matrix}$$

Actual deblocking process is performed on the vertical boundary and the horizontal boundary in this order.

(Deblocking Effect Evaluator 102)

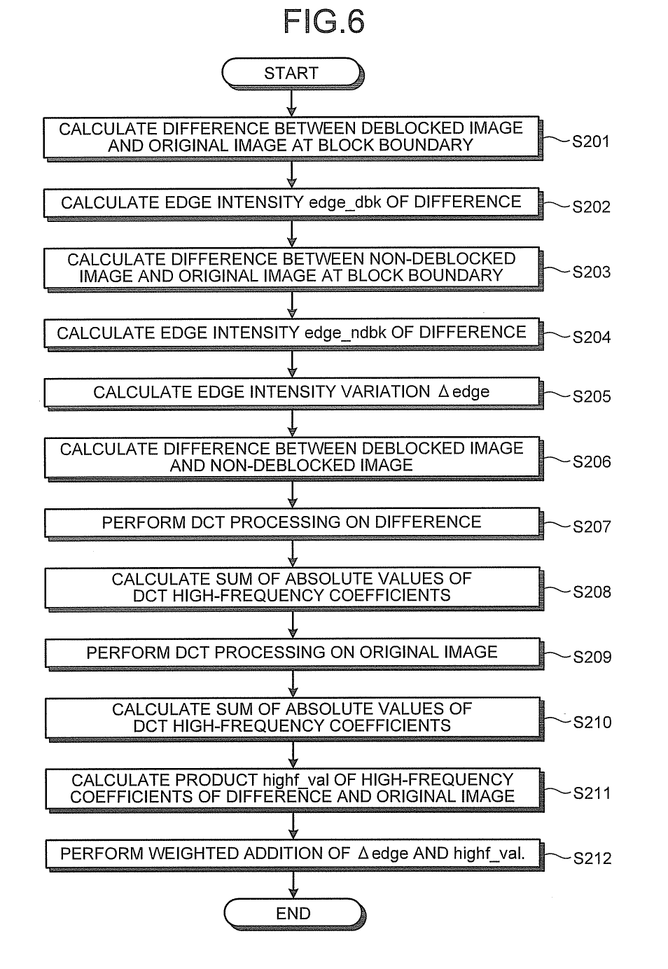

The deblocking effect evaluator 102 evaluates the effect of the deblocking process for each MB. The evaluation is performed based on the amount of variation in the edge intensity at the DCT block boundary and the amount of reduction in high-frequency components, which are caused by the deblocking filter. FIG. 6 illustrates a flowchart of a procedure of evaluating the effect of the deblocking process.

First, the amount of variation in the edge intensity at a block boundary is calculated. The deblocking effect evaluator 102 calculates a difference in pixel values between the image after the deblocking and a corresponding input image at the block boundary portion (S201). Assuming that pij_in is a pixel value of the original image and pij_dbk is a pixel value after the deblocking, a difference pixel Δpij is calculated by Expression (5).

Δpij=pij_in−pij_{—}dbk (5)

Furthermore, an edge intensity edge_dbk at the block boundary in the deblocking process is calculated for each MB according to Expression (6) (S202).

$$edge\_dbk = {\sum }_{k = 0}^{M - 1} {\sum }_{j = 0}^{N - 1} \vert Δ {p}_{k 0 j} - Δ {q}_{k 0 j} \vert + {\sum }_{l = 0}^{M - 1} {\sum }_{i = 0}^{N - 1} \vert Δ {r}_{li 0} - Δ {q}_{li 0} \vert \qquad ( 6 )$$

Similarly, for the input image and a non-deblocked image, a difference in pixel values between these images is obtained and an edge intensity edge_ndbk of the non-deblocked image is calculated. Assuming that a pixel value of the non-deblocked image is pij_ndbk, edge_ndbk is obtained by calculating a difference according to Expression (5) by substituting pij_dbk with pij_ndbk (S203), and then applying Expression (6) (S204).

Then, an edge intensity difference Δedge that is the amount of variation in the edge intensity between the deblocking process and the non-deblocking process is calculated by Expression (7) (S205).

Δedge=(edge_{—}dbk−edge_{—}ndbk) (7)

Because edge_dbk and edge_ndbk represent the edge intensities obtained at the block boundary due to coding distortion, a more decreased value of Δedge indicates that the edge intensity due to the coding distortion is more reduced by the deblocking process, thus indicating that the deblocking process is effective.

Next, the amount of reduction that occurs in the high-frequency components due to the deblocking filter is calculated. A difference between the deblocked image and the non-deblocked image is calculated based on the pixel value pij_dbk after the deblocking and the pixel value pij_ndbk of the non-deblocked image in the same manner as with Expression (5) (S206). The DCT is performed on the obtained difference (S207), frequency components of a difference signal are obtained, and a sum-of-absolute-value highf_sum_dbk of high-frequency components is calculated according to Expression (8) (S208).

$$highf\_sum \_dbk = {\sum }_{h = 0}^{{DCT}_{num} - 1} {\sum }_{i = {N}_{DCT} / 2}^{{N}_{DCT} - 1} {\sum }_{j = {N}_{DCT} / 2}^{{N}_{DCT} - 1} \vert {f}_{hij} \vert \qquad ( 8 )$$

In Expression (8), N_{DCT} represents a DCT size and DCTₙᵤₘ represents the number of DCT blocks in the MB. Furthermore, f represents a frequency component, a suffix h is an index of a DCT block in the MB, and suffixes i and j are indices for a two-dimensional frequency in the DCT block. For example, when the DCT is performed with a size of 4×4 (N_{DCT}=4), the sum of absolute values of the components is calculated in an upper band of 2×2 of each DCT block for which DCTₙᵤₘ=16.

The DCT is also performed on the input image in the same manner (S209), and a sum-of-absolute-value highf_sum_in of its high-frequency components is calculated (S210). Then, a high-frequency evaluation value highf_val that is an evaluation value of the amount of reduction that occurs in the high-frequency components due to the deblocking filter is calculated according to Expression (9) (S211).

highf_val=highf_sum_in×highf_sum_{—}dbk (9)

The high-frequency evaluation value highf_val becomes large when a high-frequency component of the original image is large and a high-frequency component lost due to the deblocking process is also large, i.e., when a large number of high-frequency components are present in the original image and if the high-frequency components are lost due to the effect of the deblocking process and the image after the deblocking process is blurred.

Lastly, an evaluation value dbk_val of the deblocking process is calculated by obtaining a weighted sum of Δedge and highf_val according to Expression (10) (S212). Here, A and B are arbitrary weights. It is indicated that the effect of the deblocking increases as the value of dbk_val decreases.

dbk_val=A×Δedge+B×highf_val (10)

The value of dbk_val calculated here is output to the storage unit 103.

(Storage Unit 103)

The storage unit 103 stores therein the evaluation value dbk_val calculated by the deblocking effect evaluator 102, and val_for_alpha and val_for_beta sent by the deblocking processor 101, for one frame for each MB. The storage unit 103 outputs the stored data to the deblocking threshold calculating unit 104 after the coding of the image for one frame is completed.

(Deblocking Threshold Calculating Unit 104)

The deblocking threshold calculating unit 104 calculates the thresholds α and β for coding a next frame and the application range based on the evaluation value dbk_val, val_for_alpha, and val_for_beta input by the storage unit 103.

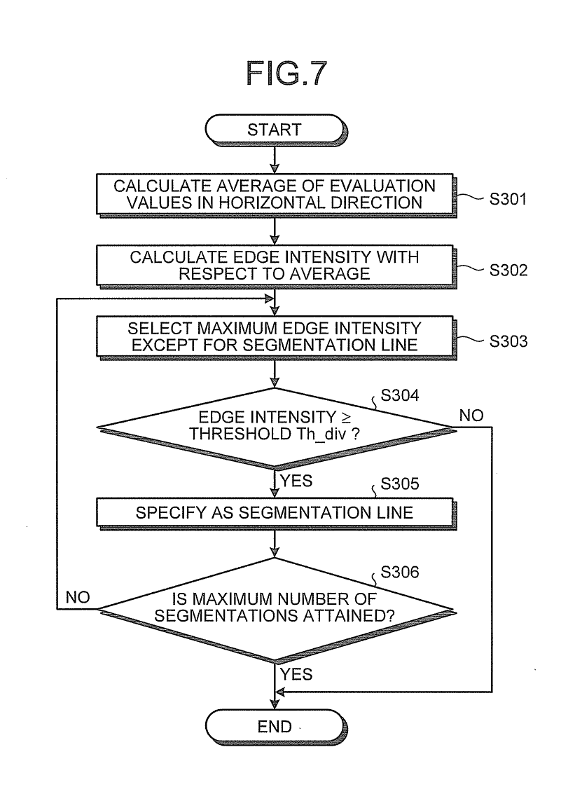

FIG. 7 illustrates a flowchart of a procedure of segmenting the threshold application range in the horizontal direction. It is also possible to segment the threshold application range in the vertical direction. In the following, explanation is given with an example in which the threshold application range is segmented in the horizontal direction; however, the threshold application range can be segmented in the vertical direction in the same manner as described below by substituting the horizontal direction with the vertical direction.

The application range of a certain threshold is determined such that, for example, an average of the evaluation values dbk_val of the MBs arranged side by side in the horizontal direction is calculated, and then a portion where the average steeply changes along the vertical direction is set to be a boundary (segmentation line) for the segmentation in the horizontal direction.

Specifically, it is assumed that the number of MBs in the horizontal direction within one frame is Width, the number of MBs in the vertical direction within one frame is Height, and an evaluation value at the coordinate (i, j) of an MB in the frame is dbk_val_ij (i=0, . . . , Width−1 and j=0, . . . , Height−1). The deblocking threshold calculating unit 104 calculates an average avg_dbk_val_j of dbk_val in the horizontal direction with respect to each vertical coordinate j of the MB according to Expression (11) (S301).

$$avg\_dbk \_val \_j = \frac{{\sum }_{i = 0}^{Width - 1} dbk\_val \_ij}{Width} \qquad ( 11 )$$

That is, the deblocking threshold calculating unit 104 calculates the horizontal average avg_dbk_val_j for each of all the rows containing the MBs arranged with respect to each vertical coordinate from j=0 to Height−1, according to Expression (11) (S301). Then, the deblocking threshold calculating unit 104 calculates a difference (edge intensity) Δavg_dbk_val_j between the averages avg_dbk_val_j and avg_dbk_val_j−1 of the MBs that are adjacent to each other in the vertical direction in a range from j=1 to Height−1, according to Expression (12) (S302).

Δavg_{—}dbk_val_{—}j=|avg_{—}dbk_val_{—}j−1−avg_{—}dbk_val_{—}j| (12)

The deblocking threshold calculating unit 104 selects the maximum value Δavg_dbk_val_max from as many as Height−1 differences Δavg_dbk_val_j calculated from j=1 to Height−1 by Expression (12)(S303). When Δavg_dbk_val_max is equal to or greater than a threshold Th_div (YES at S304), the coordinate j that gives the maximum value Δavg_dbk_val_max is set as a position of the segmentation line in the horizontal direction (S305). When Δavg_dbk_val_max is smaller than the threshold Th_div (NO at S304), the processing ends without segmentation. The threshold Th_div is a threshold used for determining a region in which it is desirable to perform identical deblocking process, and is also used for determining that, when the edge intensity (Δavg_dbk_val_j) exceeds this value, the effect of the deblocking process differs by the boundary as a boarder of difference.

When the segmentation is not performed until the maximum number of segmentations specified in advance (NO at S306), the maximum value Δavg_dbk_val_max except for Δavg_dbk_val_j that has already been set as the segmentation line is selected again (S303), comparison with the threshold Th_div is performed, and the setting of the segmentation line is repeated. When the maximum number of segmentations is attained (YES at S306) or when Δavg_dbk_val_max is smaller than Th_div (NO at S304), the segmentation ends. The maximum number of segmentations specified here can be increased and decreased depending on increase and decrease in the image size. However, the maximum number of segmentations is a value that is preferably set by taking into account the amount of whole codes including α and β set for each segmented region as described below.

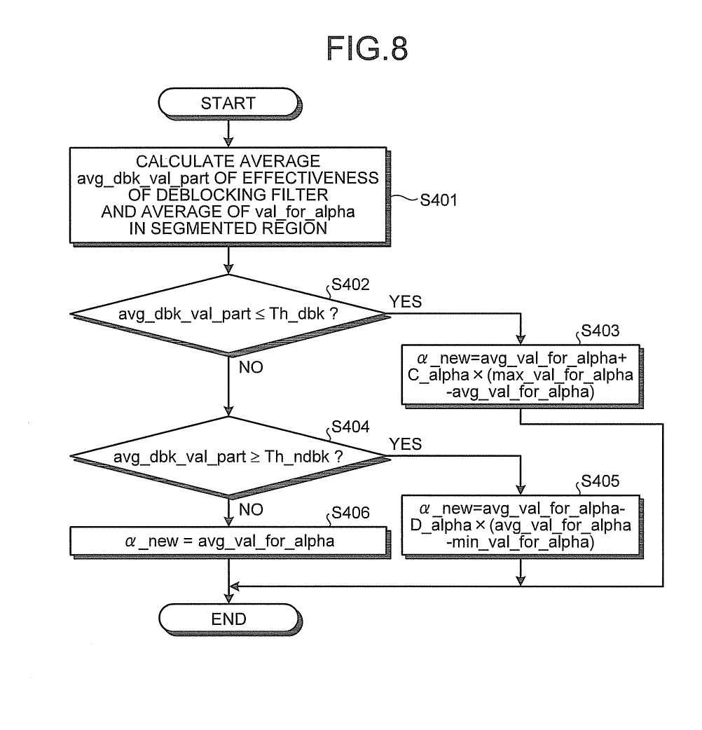

Then, a region between the segmentation lines next to each other in the vertical direction is used as the application range for α and β determined by the following method, and an update value α_new for α used in the application range is determined by the processing shown in the flowchart of FIG. 8. Even when the segmentation is not performed as a result of the procedure shown in the flowchart of FIG. 7, or even when the segmentation is not performed all along, the following explanation can be applied by assuming that one frame corresponds to the application range. In the following, the method of setting α_new is explained as an example; however, the method of setting β_new for β used in the application range is the same.

First, an average avg_val_for_alpha of val_for_alpha and an average avg_dbk_val_part of dbk_val in the segmented region are calculated (S401). The average avg_dbk_val_j in the horizontal direction, which is an average of dbk_val (i.e., dbk_val_ij) of each MB in one frame with respect to the vertical coordinate j of the MB, is already obtained (S301 and Expression (11)). Therefore, avg_dbk_val_part can be obtained by averaging out avg_dbk_val_j in the vertical direction within the segmented region, i.e., between the top segmentation line and the bottom segmentation line that define the segmented region.

When the value of avg_dbk_val_part is equal to or smaller than a threshold Th_dbk (YES at S402), the maximum value max val_for_alpha and the average avg_val_for_alpha of the val_for_alpha in the segmented region are applied to Expression (13) to obtain α_new (S403). Here, C_alpha is an arbitrary weighted coefficient in a range from 0 to 1. The threshold Th_dbk is a threshold used for determining that, when the value of avg_dbk_val_part is equal to or smaller than this value, the effect of the deblocking process is high.

α_new=avg_val_for_alpha+C_alpha×(max_val_for_alpha−avg_val_for_alpha) (13)

When the value of avg_dbk_val_part is small, the effect due to the deblocking process in this region is high, so that it is designed such that the deblocking filter is more likely to be applied. When the value of avg_dbk_val_part is greater than the threshold Th_dbk (NO at S402), the processing proceeds to S404.

When the value of avg_dbk_val_part is equal to or greater than a threshold Th_ndbk (YES at S404), the minimum value min_val_for_alpha and the average avg_val_for_alpha of val_for_alpha in the segmented region are applied to Expression (14) to obtain α_new so that the deblocking filter is less likely to be applied (S405). Here, D_alpha is an arbitrary weighted coefficient in a range from 0 to 1. The threshold Th_ndbk is a threshold used for determining that, when the value of avg_dbk_val_part is equal to or greater than this value, the effect of the deblocking process is low. In general, Th_ndbk becomes greater than Th_dbk; however, these thresholds are parameters that empirically determined based on the effects of the deblocking process in other images or the like.

α_new=avg_val_for_alpha+D_alpha×(avg_val_for_alpha−min_val_for_alpha) (14)

When avg_dbk_val_part is other than the above (NO at S404), it is determined as follows (S406).

α_new=avg_val_for_alpha (15)

When calculating β_new, the same calculation as described above can be applied by using C_beta instead of the above weighted coefficient C_alpha and D_beta instead of D_alpha.

The update value α_new and the update value β_new are calculated by the above-described method as an identical application range of α and β for each of all the segmented regions. When coding a next frame, the deblocking threshold calculating unit 104 sets the update values α_new and β_new obtained for each application range to the deblocking processor 101. Furthermore, the deblocking threshold calculating unit 104 adds information for specifying the update values α_new and β_new and the application range to coding information, and outputs the coding information to the entropy coding unit 105. The entropy coding unit 105 performs coding based on a deblocking coding parameter determined based on the update values α_new and β_new. In this case, coding is performed by including the information related to the application range of the coding parameter (application range of anew and β_new).

As described above, according to the embodiment, the thresholds used for determining ON/OFF of the deblocking filter are obtained based on the evaluation of a result of the deblocking process performed on the image that is coded just before a target image. Consequently, it is possible to appropriately evaluate the reduction in block noise and blurring caused by the deblocking, enabling to adjust the application of the deblocking process on a next input image. Furthermore, it is possible to specify a threshold for ON/OFF of the deblocking filter for each segmented region, so that the amount of codes can be reduced compared with the case in which a flag for ON/OFF of the deblocking filter is assigned for each MB.

Moreover, the amount of reduction in block noise due to the deblocking is evaluated based on the evaluation value of the edge intensity, and blurring due to the deblocking is evaluated based on the evaluation value of the high-frequency component. Because region segmentation is performed based on the evaluation values of the effect of each deblocking, it is possible to set the threshold of ON/OFF of the deblocking in an appropriate range.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving image coding apparatus comprising:
a prediction image generator that generates a prediction image based on input moving image data;
a deblocking processor that performs deblocking process based on residual data generated based on a prediction residual that is a difference between an input image constituting the moving image data and the prediction image, and the prediction image;
a deblocking effect evaluator that evaluates the deblocking process based on the input image, the residual data, the prediction image, and the deblocked data;
a deblocking parameter determiner that calculates a threshold for determining presence or absence of the deblocking process based on a result of the evaluation performed by the deblocking effect evaluator, and determines a coding parameter for deblocking based on the threshold; and
an encoder that codes the moving image data based on the prediction residual and the coding parameter.

2. The moving image coding apparatus according to claim 1, wherein
the deblocking process unit performs the deblocking process on a non-deblocked image that is a result of addition of the residual data and the prediction image,
the deblocking effect evaluator evaluates the deblocking process based on an edge intensity difference between a first edge intensity and a second edge intensity, the first edge intensity being a sum of absolute values of the amounts of variation in differences between the deblocked data and the input image at a boundary of DCT blocks each containing a plurality of pixels, and the second edge intensity being a sum of absolute values of the amounts of variation in differences between the non-deblocked image and the input image at the boundary of the DCT blocks, and
the encoder codes the moving image data based on a result obtained by performing DCT on the prediction residual in units of the DCT blocks, and the coding parameter.

3. The moving image coding apparatus according to claim 1, wherein
the deblocking process unit performs the deblocking process on a non-deblocked image that is a result of addition of the residual data and the prediction image,
the deblocking effect evaluator evaluates the deblocking process based on a high-frequency evaluation value that is a product of a sum of absolute values of high-frequency components, which are obtained by performing DCT on a difference between the deblocked data and the non-deblocked image in units of DCT blocks each containing a plurality of pixels, and a sum of absolute values of high-frequency components, which are obtained by performing DCT on the input image in units of the DCT blocks, and
the encoder codes the moving image data based on a result obtained by performing DCT on the prediction residual in units of the DCT blocks, and the coding parameter.

4. The moving image coding apparatus according to claim 3, wherein
the deblocking effect evaluator calculates a weighted sum of the high-frequency evaluation value and an edge intensity difference between a first edge intensity and a second edge intensity, the first edge intensity being a sum of absolute values of the amounts of variation in differences between the deblocked data and the input image at a boundary of the DCT blocks, and the second edge intensity being a sum of absolute values of the amounts of variation in differences between the non-deblocked image and the input image at the boundary of the DCT blocks, and evaluates the deblocking process based on the weighted sum and the edge intensity difference.

5. The moving image coding apparatus according to claim 4, wherein
the deblocking parameter determiner segments a frame of the moving image data into a plurality of regions based on the result of the evaluation, and calculates the threshold for each region.

6. The moving image coding apparatus according to claim 5, wherein
the frame includes a plurality of macroblocks,
each of the macroblocks includes one or more of the DCT blocks,
the deblocking effect evaluator calculates an evaluation value for each macroblock for evaluating the deblocking process, and
the deblocking parameter determiner calculates an average of the evaluation values of the respective macroblocks in a parallel to a direction of a boundary of the regions, determines the regions based on a boundary at which variation in the average in a perpendicular to the direction of the boundary of the regions exceeds a predetermined value, and calculates the threshold based on an average of the evaluation values in each region and an average of differences between adjacent pixel values at a boundary of the DCT blocks in each region in the non-deblocked image.

7. The moving image coding apparatus according to claim 1, wherein
the deblocking parameter determiner segments a frame of the moving image data into a plurality of regions based on the result of the evaluation, and calculates the threshold for each region.

8. The moving image coding apparatus according to claim 7, wherein
the frame includes a plurality of macroblocks,
the deblocking effect evaluator calculates an evaluation value for each macroblock for evaluating the deblocking process, and
the deblocking parameter determiner calculates an average of the evaluation values of the respective macroblocks in a parallel to a direction of a boundary of the regions, and determines the regions based on a boundary at which variation in the average in a perpendicular to the direction of the boundary of the regions exceeds a predetermined value.

9. The moving image coding apparatus according to claim 8, wherein
the encoder codes the moving image data based on the coding parameter and a result obtained by performing DCT on the prediction residual in a unit of a DCT block containing a plurality of pixels, and
each of the macroblocks includes one or more of the DCT blocks.

10. The moving image coding apparatus according to claim 9, wherein
the deblocking parameter determiner calculates the threshold based on an average of the evaluation values in each region and an average of differences between adjacent pixel values at the boundary of the DCT blocks for a result obtained by addition of the residual data and the prediction image in each region.

11. A moving image coding method comprising:
generating a prediction image based on input moving image data;
performing deblocking process based on residual data generated based on a prediction residual that is a difference between an input image constituting the moving image data and the prediction image, and the prediction image;
evaluating the deblocking process based on the input image, the residual data, the prediction image, and the deblocked data;
calculating a threshold for determining presence or absence of the deblocking process based on a result of the evaluation performed at the evaluating;
determining a coding parameter for deblocking based on the threshold; and
coding the moving image data based on the prediction residual and the coding parameter.

12. The moving image coding method according to claim 11, wherein
the performing includes performing the deblocking process on a non-deblocked image that is a result of addition of the residual data and the prediction image,
the evaluating includes evaluating the deblocking process based on an edge intensity difference between a first edge intensity and a second edge intensity, the first edge intensity being a sum of absolute values of the amounts of variation in differences between the deblocked data and the input image at a boundary of DCT blocks each containing a plurality of pixels, and the second edge intensity being a sum of absolute values of the amounts of variation in differences between the non-deblocked image and the input image at the boundary of the DCT blocks, and
the coding includes coding the moving image data based on a result obtained by performing DCT on the prediction residual in units of the DCT blocks, and the coding parameter.

13. The moving image coding method according to claim 11, wherein
the performing includes performing the deblocking process on a non-deblocked image that is a result of addition of the residual data and the prediction image,
the evaluating includes evaluating the deblocking process based on a high-frequency evaluation value that is a product of a sum of absolute values of high-frequency components, which are obtained by performing DCT on a difference between the deblocked data and the non-deblocked image in units of DCT blocks each containing a plurality of pixels, and a sum of absolute values of high-frequency components, which are obtained by performing DCT on the input image in units of the DCT blocks, and
the coding includes coding the moving image data based on a result obtained by performing DCT on the prediction residual in units of the DCT blocks, and the coding parameter.

14. The moving image coding method according to claim 13, wherein
the evaluating includes
calculating a weighted sum of the high-frequency evaluation value and an edge intensity difference between a first edge intensity and a second edge intensity, the first edge intensity being a sum of absolute values of the amounts of variation in differences between the deblocked data and the input image at a boundary of the DCT blocks, and the second edge intensity being a sum of absolute values of the amounts of variation in differences between the non-deblocked image and the input image at the boundary of the DCT blocks, and
evaluating the deblocking process based on the weighted sum and the edge intensity difference.

15. The moving image coding method according to claim 14, wherein
the determining includes
segmenting a frame of the moving image data into a plurality of regions based on the result at the evaluating, and
calculating the threshold for each region.

16. The moving image coding method according to claim 15, wherein
the frame includes a plurality of macroblocks,
each of the macroblocks includes one or more of the DCT blocks,
the evaluating includes calculating an evaluation value for each macroblock for evaluating the deblocking process, and
the determining includes
calculating an average of the evaluation values of the respective macroblocks in a parallel to a direction of a boundary of the regions,
determining the regions based on a boundary at which variation in the average in a perpendicular to the direction of the boundary of the regions exceeds a predetermined value, and
calculating the threshold based on an average of the evaluation values in each region and an average of differences between adjacent pixel values at a boundary of the DCT blocks in each region in the non-deblocked image.

17. The moving image coding method according to claim 11, wherein
the determining includes
segmenting a frame of the moving image data into a plurality of regions based on the result at the evaluating, and
calculating the threshold for each region.

18. The moving image coding method according to claim 17, wherein
the frame includes a plurality of macroblocks,
the evaluating includes calculating an evaluation value for each macroblock for evaluating the deblocking process, and
the determining includes
calculating an average of the evaluation values of the respective macroblocks in a parallel to a direction of a boundary of the regions, and
determining the regions based on a boundary at which variation in the average in a perpendicular to the direction of the boundary of the regions exceeds a predetermined value.

19. The moving image coding method according to claim 18, wherein
the coding includes coding the moving image data based on the coding parameter and a result obtained by performing DCT on the prediction residual in a unit of a DCT block containing a plurality of pixels, and
each of the macroblocks includes one or more of the DCT blocks.

20. The moving image coding method according to claim 19, wherein
the determining includes calculating the threshold based on an average of the evaluation values in each region and an average of differences between adjacent pixel values at the boundary of the DCT blocks for a result obtained by addition of the residual data and the prediction image in each region.
